(19) United States
(12) Patent Application Publication
(10) Pub. No.: US 2018/0127637 A1
(43) Pub. Date: May 10, 2018

(54) METHODS OF ENHANCING OIL RECOVERY

(71) Applicant: The Board of Regents of the University of Oklahoma, Norman, OK (US)

(72) Inventors: Jeffrey Harwell, Norman, OK (US); Ben Shiau, Norman, OK (US); Mohannad Kadhum, Norman, OK (US); Shuoshi Wang, Norman, OK (US)

(21) Appl. No.: 15/720,362

(22) Filed: Sep. 29, 2017

Related U.S. Application Data
(60) Provisional application No. 62/402,116, filed on Sep. 30, 2016.

(51) Int. Cl. C09K 8/594; B01J 23/22; B01J 21/08; B01J 21/18; B01J 35/00; E21B 43/16

(52) U.S. Cl. CPC C09K 8/594; B01J 23/22; B01J 21/08; C09K 2208/10; B01J 35/0013; B01J 35/0006; E21B 43/164; B01J 21/185

(57) ABSTRACT

Methods of using compositions containing highly water soluble CO₂-generating compounds for injection into subterranean formations for enhancing oil recovery from reservoirs therein. The compositions may optionally include a catalyst. The reservoirs may be unconventional.

### CROSS-REFERENCE TO RELATED APPLICATIONS

This application claims benefit under 35 U.S.C. 119(e) of U.S. Provisional Application Ser. No. 62/402,116, filed Sep. 30, 2016, the entirety of which is hereby expressly incorporated herein by reference.

### BACKGROUND

Carbon dioxide (CO₂) flooding of oilfields around the world has proven to be a successful practice for increasing oil production from oil reservoirs, particularly in marginal wells with low production rates. The limitations to this technology lie in the limited supply of CO₂, high capital cost, and corrosion. Further, CO₂ flooding in offshore reservoirs is considered to be impractical because of the problems of transporting the CO₂ to the well head. Methods for enhancing oil recovery which do not suffer from these limitations and shortcomings would be desirable.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the inventive concepts disclosed herein. The figures are not necessarily to scale and certain features and certain views of the figures may be shown as exaggerated in scale or in schematic in the interest of clarity and conciseness.

FIG. 1 is a schematic diagram of flow system used in certain experiments described herein.

FIG. 2 is a schematic diagram of in situ CO₂ extraction system used in certain experiments described herein.

FIG. 3 demonstrates the effect of ammonium carbamate (AC) injection on increasing oil recovery in a core flood experiment.

FIG. 4 shows results of flooding a sandpack with a urea solution at 0.03 mL/min.

FIG. 5 shows results of flooding a sandpack with a urea solution at 0.08 mL/min.

FIG. 6 shows results of urea hydrolysis kinetic measurements.

### DETAILED DESCRIPTION

The present disclosure is directed to, in at least certain embodiments, injecting certain water soluble CO₂-generating compounds into an subterranean (underground) formation (for example a formation comprising a reservoir of petroleum and/or natural gas) to cause in situ CO₂ generation for an enhanced oil recovery (EOR) operation. One or more water soluble CO₂-generating compounds are dissolved in water, which may include seawater or brine, to form a treatment solution which is injected into the reservoir where it decomposes (dissociates) at reservoir conditions of temperature and pressure, generating CO₂. The properties of the treatment solution can improve oil and/or gas recovery (e.g., in an EOR application), for example, by causing oil phase swelling, reduction of the oil viscosity, and/or by reducing oil-water interfacial tension. In situ catalysis may be used to enhance decomposition of the water soluble CO₂-generating compounds or modify interfacial tension and wettability of rock walls, for example. The treatment solution may be combined with a fracturing fluid. Upon contacting oil in the reservoir, the CO₂ migrates to the oil phase resulting in oil phase swelling and reduction of the oil viscosity, which results in incrementally-increased oil production. In certain embodiments, the estimated incremental recovery factor caused by this technology may be, for example, about 1% to about 35% beyond that seen with conventional water flooding, or for example, about 5% to about 25% beyond that seen with conventional water flooding. In certain embodiments the methods disclosed herein are used to enhance extraction of oil and/or gas from unconventional reservoirs.

Before further describing various embodiments of the compositions and methods of the present disclosure in more detail by way of exemplary description, examples, and results, it is to be understood that the embodiments of the present disclosure are not limited in application to the details of methods and compositions as set forth in the following description. The embodiments of the compositions and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. All of the compositions and methods of production and application and use thereof disclosed herein can be made and executed without undue experimentation in light of the present disclosure. While the compositions and methods of the present disclosure have been described in terms of particular embodiments, it will be apparent to those of skill in the art that variations may be applied to the compositions and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000.

A pore volume (“PV”), as used herein, refers to the volume of fluid required to replace (flush out) the water or other fluid in a certain volume of a saturated porous medium, for example, a core of Berea Sandstone™ or a column of Berea sand.

Where used herein the term “highly water soluble CO₂-generating compound” refers to a compound having at least 1 percent solubility in freshwater or saltwater as measured in weight percent (wt %) units and which generates CO₂ upon dissociation (decomposition) or hydrolysis. In certain non-limiting embodiments, the highly water soluble CO₂-generating compounds of the present disclosure may have water solubilities in a range of at least about 35 wt % to about 50 wt %.

The term “unconventional reservoir”, where used herein, refers to a reservoir that requires special recovery operations outside conventional operating practices, tight-gas sands, gas and oil shales, coalbed methane, heavy oil and tar sands, and gas-hydrate deposits.

Returning to the discussion of several embodiments of the present disclosure, examples of the highly water soluble CO₂-generating compounds that may be used in accordance with the methods described herein include, but are not limited to, urea and ammonium carbamate (AC). In certain embodiments, a treatment solution comprising AC, urea, and/or related compounds, or combinations thereof, is injected into the reservoir in a manner known in the art. After injection, AC (H₂NCOONH₄) and urea (H₂NCONH₂), which are water-soluble chemicals, dissociate at reservoir temperature producing CO₂ and ammonia (NH₃). The CO₂ migrates to the oil phase, causing oil phase swelling and reduction in oil viscosity, therefore increasing oil production. The NH₃ dissolves in the water, and the NH₃-water solution increases the water wettability of the rock which also leads to increased production. In at least certain embodiments of the present disclosure, the water soluble CO₂-generating compounds are introduced into the underground oil reservoir without a surfactant and/or without a chelating agent. In some situations it might be advantageous to include in the solution a common chelating agent such as citric acid or EDTA to prevent precipitation of the carbamate ion by divalent ions in the water.

AC is water soluble to about 35% by weight (wt %) and urea is water soluble to about 50 wt %. Thus an enhanced oil recovery operation of the present disclosure could use a solution comprising a concentration of the water soluble CO₂-generating compound(s) in a range of about 1 wt % to about 50 wt %, although at current or immediately foreseeable oil prices (e.g., $50-$60/barrel) such concentrations are likely to be uneconomical. A more likely scenario for using these solutions in enhanced oil recovery operations would be to use a solution comprising a concentration of the water soluble CO₂-generating compound(s) in a range of about 1 wt % to about 15 wt %, such as in a range of about 1 wt % to about 12 wt %, about 2 wt % to about 10 wt %, or about 5 wt % to about 8 wt %. More particularly, the concentration may be about 1%, about 2%, about 3%, about 4%, about 5%, about 6%, about 7%, about 8%, about 9%, about 10%, about 11%, about 12%, about 13%, about 14%, or about 15%.

Unlike conventional CO₂ flooding, AC and urea flooding is effective at both low pressures and at high pressures. There is not a significant increase in recovery for reservoir pressures above the critical point of CO₂ or above the minimum miscibility pressure of supercritical CO₂. There are no practical pressure limits on the applicability of the technology. There are, however, temperature limits. While there is no upper limit to the temperature at which the technology will produce incremental oil recovery beyond water flooding, the temperature must be high enough to allow thermal decomposition of the AC or the urea at a reasonable rate. A practical lower limit is about 70° C. In at least certain embodiments, the temperature is in a range of about 70° C. to about 120° C. In at least certain embodiments, the temperature is in a range of about 80° C. to about 100° C. In at least certain embodiments, the temperature is in a range of about 85° C. to about 95° C. In at least certain embodiments, the temperature is at least about 90° C.

In certain embodiments, the lower limit can be extended by combining the urea or AC with a suitable catalyst. In one non-limiting embodiment, the catalyst may be vanadium pentoxide which catalyzes thermal decomposition of urea at 50° C. (as shown in U.S. Pat. No. 4,168,299) or a suitable catalytic nanoparticle, such as a carbon nanotube-silica nanohybrid nanoparticle (Villamizar, et al., SPE 129901, 2010).

In certain embodiments of the methods of the present disclosure, the injection of the solution containing at least one water soluble CO₂-generating compound into the subterranean formation causes a reduction of the residual oil saturation (Sₒᵣ) of the subterranean formation in a range of about 1% to 25%, or in a range of about 1% to 20%, or in a range of about 5% to 15% greater than a reduction which results from a conventional water flooding treatment.

### Examples

The embodiments of the present disclosure, having now been generally described, will be more readily understood by reference to the following examples and embodiments, which are included merely for purposes of illustration of certain aspects and embodiments of the present disclosure, and are not intended to be limiting. The following detailed examples of systems and/or methods of use of the present disclosure are to be construed, as noted above, only as illustrative, and not as limitations of the disclosure in any way whatsoever. Those skilled in the art will promptly recognize appropriate variations from the various structures, components, compositions, procedures, and methods.

In the experiments described in the following examples, the effects of various types of treatment solutions of water soluble CO₂-generating compounds has been assessed, thus providing information about which systems of water soluble CO₂-generating compounds result in CO₂ generation, oil phase swelling, or wettability within sand or rock samples. These analyses are directly relatable to how such solutions would act in natural subterranean rock formations. Validation of the results was confirmed by column propagation studies using crushed sandstone columns and core flooding. It is thus feasible to extrapolate the extent of the effects of the solutions of water soluble CO₂-generating compounds injected into rock in a laboratory system to a subterranean reservoir-sized system, for example for EOR.

### EXPERIMENTAL

1. Injection with AC

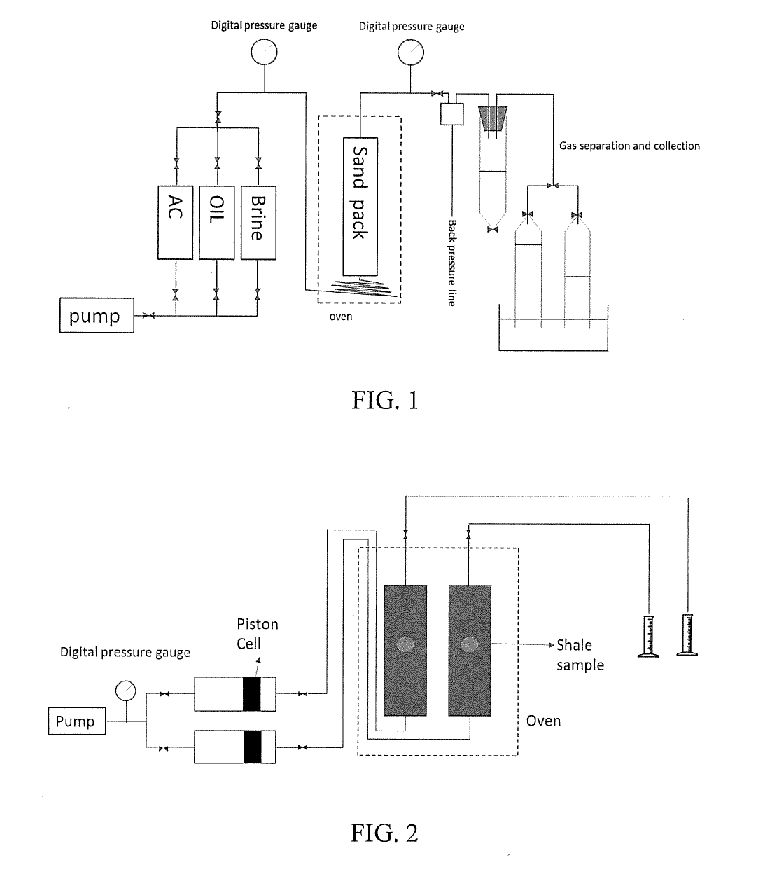

Experiments were conducted using a 5″ to 6″ length stainless steel column packed with crushed Berea sandstone or Ottawa sand. A 5% sodium chloride was used as a background electrolyte. A schematic of a sandpack and coreflood unit used in the experiments is depicted in FIG. 1. The unit is constructed with an Isco syringe pump connected to three piston cells. The three piston cells are filled with the three injected fluids: brine, oil, and an aqueous solution of a CO₂-generating compound such as AC or urea. The fluids are injected to a Swagelok HP stainless steel column packed with sand. The column is placed inside an oven with a temperature setting up to 125° C. The effluent line is connected to a backpressure regulator situated inside a hood to release any generated gases and collect the produced fluids. The pressure rating for the system is 2000 psi. A typical delivery sequence consists of flooding brine into the porous media followed by 1-2 pore volumes (PV) of oil injection followed by 2-3 PV of brine injection. Once a stable residual oil saturation (Sₒᵣ) has been established, AC injection starts and continues for a fraction of a PV, up to 2 PV, depending on testing conditions. The eluted oil samples from column are quantified and the change in oil saturation calculated by mass balance.

As noted above, AC dissociates forming CO₂ and NH₃. CO₂ will migrate to the oil phase reducing oil viscosity and inducing swelling of the oil phase. NH₃ will increase the water wettability of the mineral surface, reducing capillary forces. Batch experiments showed that AC in aqueous solution dissociates to release CO₂ and NH₃ either with elevated temperature (up to 95° C.) or by the titration with acids such as hydrochloric acid or citric acid. Flow experiments were conducted using 6 inch Ottawa sand packs at pressures up to 80 psi and temperatures up to 125° C. The experiments demonstrated that the decomposition of a 35% AC solution injected into the sand packs resulted in further lowering of the Sₒᵣ following a standard water flood. Four more sand pack experiments were conducted at a pressure above the critical point of CO₂ (1071 psi); all demonstrated significant reduction in Sₒᵣ with the injection of AC solution. The injection of AC solution into a 100 mD Berea core aged with 22 cp crude oil resulted in bringing the recovery factor from 29% following a water flood, to 46%. This work shows the simplicity of adopting AC injection to increase oil production from onshore and offshore fields.

Preliminary Testing: High Pressure High Temperature Sand Pack Using Dodecane as Oil Phase

The three piston cells were filled with sodium chloride of 5% salinity, n-dodecane, and AC in 5% NaCl aqueous solution. Early experiments were conducted using n-dodecane as an oil phase as literature indicated that CO₂ has much higher solubility in n-dodecane than water. Multiple crushed Berea and Ottawa sand pack tests were conducted by injecting brine (5% NaCl), followed by the injection of 1-2 PV of dodecane or crude oil and then the injection of either brine or AC solution. The temperatures in the experiments were between 110° C. to 129° C. and pressures were between atmospheric and 1000 psi. The Sₒᵣ values following water flooding turned out to be very small for the dodecane, too small to demonstrate a significant change in residual dodecane oil saturation due to ammonium carbamate flooding (See Exp. Nos. 104 and 105) in Table 1.

TABLE 1
Sand pack experiments using Dodecane as oil Phase.

| | | | | | | Sₒᵣ | | Sor, | AC, |
|---|---|---|---|---|---|---|---|---|---|
| Experiment | Packing | Tested | Pressure, | Temperature, | | water | Final | Reduction, | Wt |
| # | Type | Oil | psi | ° C. | Aged | flooding | Sor | % | % |
| 101 | Crushed | dodecane | 1000 | 110 | No | 0.16 | 0.16 | 0 | 10 |
| | Berea | | | | | | | | |
| 102 | Crushed | dodecane | 200 | 120 | No | 0.26 | 0.25 | 3.8 | 10 |
| | Berea | | | | | | | | |
| 103 | Ottawa | dodecane | 150 | 129 | No | 0.32 | 0.32 | 0 | 10 |
| | sand | | | | | | | | |
| 104 | Ottawa | dodecane | 150 | 125 | No | No | 0.14 | N/A | 35 |
| | sand | | | | | primary | | | |
| | | | | | | flooding | | | |
| 105 | Ottawa | dodecane | 800 | 125 | No | 0.17 | 0.17 | 0 | 35 |
| | sand | | | | | | | | |

Testing Using Crude Oil as Oil Phase

Two additional experiments were run using a 4.6 cp crude oil. Experiment no. 106 was conducted at 250 psi and experiment no. 107 was conducted at atmospheric conditions. While the higher pressure experiment (no. 106) did not result increased oil recovery, experiment no. 107 resulted in significant oil recovery and generation of large amount of gas after the backpressure regulator.

At this point it was believed that the total pressure of the system has significant impact on oil recovery. A higher residual oil saturation was desired as well. Therefore, sand packs were aged with crude oil to increase Sₒᵣ.

Experiment nos. 108 and 109 were conducted at 50 and 80 psi, respectively. They both resulted in significant amounts of post-waterflood oil produced. These are summarized in Table 2 below. Experiment nos. 111-114 were conducted at or above saturation pressure. All three resulted in incremental oil produced, as shown in Table 2.

TABLE 2
Sand pack experiments with crude oil at pressure below CO₂ critical point.

| | | | | | | Sₒᵣ | | Sor, | AC, |
|---|---|---|---|---|---|---|---|---|---|
| Experiment | Packing | Tested | Pressure, | Temperature, | | water | Final | Reduction, | Wt |
| # | Type | Oil | psi | ° C. | Aged | flooding | Sor | % | % |
| 106 | Ottawa | 4.6 cp oil | 240 | 120 | No | 0.27 | 0.27 | 0 | 35 |
| | sand | | | | | | | | |
| 107 | Ottawa | 4.6 cp oil | atmospheric | 100 | No | 0.19 | 0.17 | 10.5 | 35 |
| | sand | | | | | | | | |
| 108 | Ottawa | 4.6 cp oil | 50 | 121 | No | 0.16 | 0.06 | 60.6 | 35 |
| | sand | | | | | | | | |
| 109 | Ottawa | 4.6 cp oil | 80 | 125 | Yes, | 0.38 | 0.17 | 55.2 | 35 |
| | sand | | | | 22 | | | | |
| | | | | | days | | | | |

Experiment no. 110 was conducted at 1150 psi and 125° C. to investigate AC decomposition above the critical pressure of CO₂. Because of a piston cell failure, the experiment was not continued. Experiment nos. 111-114 were conducted above the critical pressure of CO₂ to demonstrate the effect of super critical CO₂ on recovery. Table 3 lists the experimental details. All four experiments resulted in substantial incremental oil recovery, ranging from 21% to 33% production of residual oil after waterflooding.

TABLE 3
Sand pack experiments with crude oil at pressure above CO₂ critical point.

| | | | | | | Sₒᵣ | | Sor, | AC, |
|---|---|---|---|---|---|---|---|---|---|
| Experiment | Packing | Tested | Pressure, | Temperature, | | water | Final | Reduction, | Wt |
| # | Type | Oil | psi | ° C. | Aged | flooding | Sor | % | % |
| 111 | Ottawa | 4.6 cp oil | 1100 | 125 | Yes, | 0.39 | 0.26 | 33.3 | 35 |
| | sand | | | | 46 | | | | |
| | | | | | days | | | | |
| 112 | Ottawa | 4.6 cp oil | 1500 | 125 | Yes, | 0.46 | 0.35 | 23.9 | 35 |
| | sand | | | | 52 | | | | |
| | | | | | days | | | | |
| 113 | Ottawa | 4.6 cp oil | 1500 | 125 | Yes, | 0.51 | 0.35 | 31.4 | 35 |
| | sand | | | | 42 | | | | |
| | | | | | days | | | | |
| 114 | Ottawa | 22 cp oil | 1300 | 130 | Yes, | 0.30 | 0.236 | 21.3 | 35 |
| | sand | | | | 60 | | | | |
| | | | | | days | | | | |

Coreflooding with Crude Oil

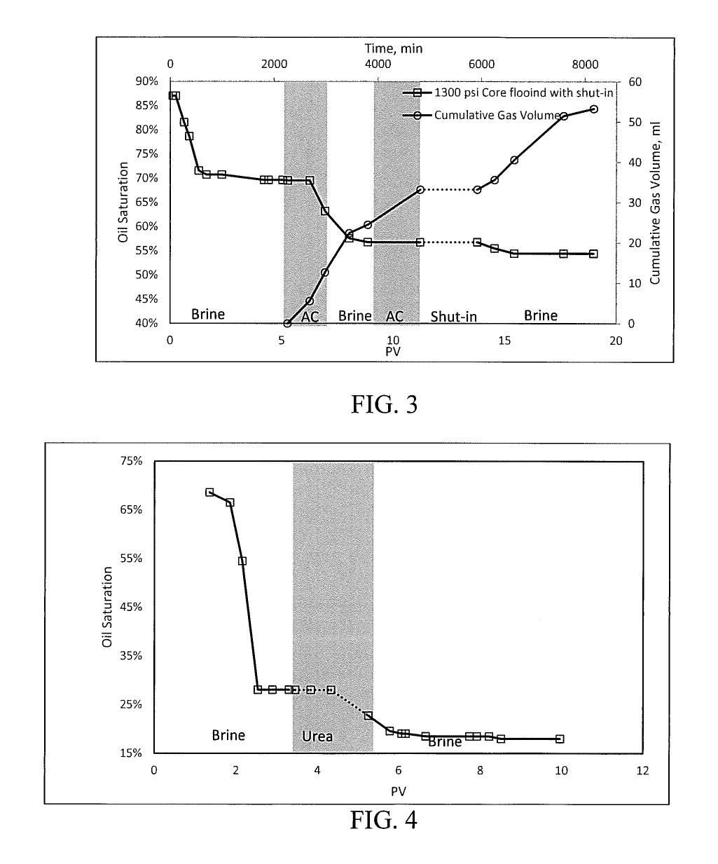

Following the successful demonstration of the process using sand packs, a 100 mD Berea core was aged using 22 cp crude oil. The core was aged for 25 days at 80° C. The experiment was run by injecting brine at 150° C. and 1300 psi to establish the Sₒᵣ, which was found to be 0.71. Subsequently, 2 PV of AC were injected, causing a reduction of Sₒᵣ to 0.54, resulting in an incremental increase in oil recovery of about 24% (FIG. 3). The injection sequence was as following: Brine; 2 PV AC solution; brine post flood; 2 PV AC solution; flow stoppage for 24 hrs; brine post flood to produce additional mobilized oil. Stopping the flow for 24 hrs did not result in significant additional oil recovery. The generated CO₂ volume is the obvious. And the gas breakthrough is at the same time as oil breakthrough.

Conclusions

The experimental data demonstrate successful in situ generation of CO₂ in an oil reservoir in rock by using AC solution injection, resulting in incremental oil recovery after waterflooding. The presently disclosed AC oil recovery enhancement technology provides ease of use, reduced process capital cost relative to typical CO₂ flooding, and avoidance of the corrosion associated with high pressure CO₂. The ease of transport of AC in the form of a powdered solid means it can be successfully implemented in a wide range of fields both onshore and offshore.

2. Injection with Urea

Urea was tested as another candidate for CO₂ generation and delivery inside oil reservoirs to increase oil recovery. Urea can be hydrolyzed in aqueous solutions with or without a catalyst to generate CO₂ and NH₃. As noted above, vanadium pentoxide can be utilized as a catalyst to enhance the rate of reaction. With or without a catalyst, urea can dissociate over a wide range of temperatures in aqueous phase to generate ammonium hydroxide in solution and carbonic acid. Urea has been used as a co-surfactant in chemical flooding to control the phase behavior of the primary surfactant.

### Experiment 1

Six inch-length stainless steel column was packed with Ottawa sand F-75. The total pressure during the experiment was 1,500 psi. The temperature was 125° C. The sand pack was pre-saturated with a 4.6 cp crude oil that has an API gravity of 44. The sandpack porosity was 35%. The experiment was conducted by flooding the column with 5% NaCl brine solution until no further oil was recovered. 2.2 PV of aqueous solution containing 35% urea and 5% NaCl by weight was injected to the sand pack at the testing conditions followed by 2 PV of brine as shown in FIG. 4. The flow rate throughout the experiment was kept constant at 0.03 ml/min. The oil saturation was decreased from 28% up to 17.9%, for a recovery of 28% of the residual oil in place after water flooding.

### Experiment 2

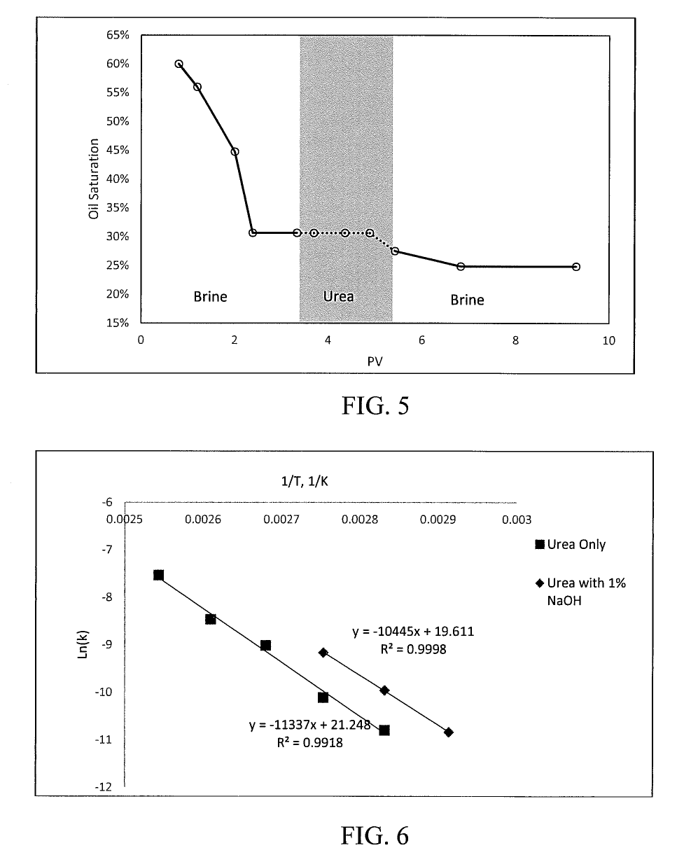

Experiment 2 was conducted with similar conditions of temperature and pressure of Experiment 1 except using a high injection rate of 0.08 mL/min. After brine flooding, the oil saturation was 30.7% and it decreased upon injecting 2.2 PV of urea solution up to 24.8%. The tertiary oil recovery was 19.2%. The apparent lower recovery at a higher flow rate might be indicative of a mass transfer controlled process, which would not be an issue in an actual reservoir where flow rates would actually be much smaller than those utilized in these experiments. The oil saturation change during the production was shown in FIG. 5.

Conclusion:

Experiments 1 and 2 demonstrated that urea injection into porous media, and the production therein of CO₂ and NH₃ increases oil recovery substantially. In accordance with the present disclosure, urea is especially attractive for in situ CO₂ generation for EOR because of its high water solubility (up to 50% by weight) and the fact that in our experiments it does not precipitate in the presence of calcium and magnesium ions, making it possible to mix directly with untreated sea water for injection in off shore reservoirs where low salinity brine might not be available.

3. Applications in Tight or Unconventional Reservoirs

Enhanced oil recovery was reported by using CO₂ injection in liquid rich shale (or extreme tight) core samples. The methods of in-situ CO₂ generation described herein can provide additional oil recovery based on as the same mechanism that occurs during CO₂ injection. The generated CO₂ diffusion and the oil swelling were the primary mechanisms that affect the trapped oil in the shale matrix. Viscosity reduction helps the oil flowing in the fracture. The experiment described below demonstrates the EOR ability of in situ CO₂ generation in liquid rich shale cores. The experimental setup shown in FIG. 2 was used.

Experiment:

Stainless steel high pressure and temperature extraction vessels were used in this experiment. Mancos core plugs were cutter into diameter and length at 1″. Mancos shale core samples were pre-saturated by dodecane. The liquid rich shale in situ CO₂ extraction was done at 4000 psi and 250° C. Two extraction vessels were installed in one test. The benchmark extraction vessel was loaded with 15% KCl (brine imbibition). Moreover, the testing extraction vessel was loaded with 15% KCl and 35% urea. Three cores were sealed with brine or gas generating agent solution in each extraction vessel and heated at 250° C. The extraction vessel pressure was stabilized at 4000 psi despite heating by a syringe pump during the whole experiment. After seven days heating, after releasing the pressure generated by CO₂ and cooling the system down to room temperature, the recovered oil from the liquid rich shale was measured. The brine imbibition and in situ CO₂ extraction showed oil recovery at 0% and 39% respectively. These new formulations for in situ CO₂ extraction showed obvious use for liquid rich shale EOR.

4. Catalytic Urea Hydrolysis

The production of CO₂ and ammonia from urea hydrolysis involves two steps:
NH₂CONH₂+H₂O→NH₂COONH₄
NH₂COONH₄→2NH₃+CO₂
   Urea hydrolysis data from lab scale experiment enables scale up to field scale project designs. The kinetic data was acquired accurately in this work. Urea hydrolysis testing was done at a range of temperatures from 70° C. to 120° C. This temperature range not only covered the sand pack flooding experiment conditions but also the lower temperature. It can enable this technique to be used in shallow oil reservoirs.

Experiments:

To get an isolated system at elevated temperature and pressure, microwave reactors were used to seal the urea solution. Each reactor contained 5 ml of urea solution. The urea solutions were heated to testing temperature. After the reaction, the urea solution was cooled and analyzed by HPLC to determine the urea concentration change. 10 wt. % urea solutions were prepared for urea hydrolysis tests. For catalytic urea hydrolysis, solutions of 10 wt. % urea with 1 wt. % NaOH was prepared. From the measured kinetic data, urea hydrolyzed without catalyst at temperature from 80° C. to 120° C. and with 1 wt. % NaOH at a temperature from 70° C. to 90° C. Urea hydrolysis without catalyst showed a much lower reaction rate than catalytic hydrolysis. Therefore, it could be concluded that (a) urea could be hydrolyzed at a temperature above 70° C., and (b) basic conditions provided by NaOH could increase the urea hydrolysis rate. The measured reaction constants were shown in FIG. 6.

In accordance with the foregoing, the present disclosure is directed to, in at least some embodiments, the following:

Clause 1. A method for enhancing recovery from a subterranean formation, comprising injecting a treatment solution containing at least one water soluble CO₂-generating compound into a subterranean formation containing oil and/or natural gas, wherein the at least one water soluble CO₂-generating compound dissociates to form CO₂, thereby enhancing recovery of at least one of oil and natural gas recovery therefrom.
Clause 2. The method of clause 1, wherein the at least one water soluble CO₂-generating compound is selected from the group consisting of ammonium carbamate and urea.
Clause 3. The method of either of clauses 1 or 2, wherein the concentration of the at least one water soluble CO₂-generating compound in the treatment solution is in a range of about 1% to about 15%.
Clause 4. The method of any one of clauses 1-3, wherein the concentration of the at least one water soluble CO₂-generating compound in the treatment solution is in a range of about 2% to about 10%.
Clause 5. The method of any one of clauses 1-4, wherein the concentration of the at least one water soluble CO₂-generating compound in the treatment solution is in a range of 5% to 8%.
Clause 6. The method of any one of clauses 1-5, wherein injection of the treatment solution into the subterranean formation causes at least one of oil phase swelling, reduction of oil viscosity, and reduction of oil-water interfacial tension in the subterranean formation.
Clause 7. The method of any one of clauses 1-6, wherein injection of the treatment solution into the subterranean formation causes a reduction of the residual oil saturation (Sₒᵣ) of the subterranean formation of at least 1% more than a reduction resulting from a conventional water flooding treatment.
Clause 8. The method of any one of clauses 1-7, wherein injection of the treatment solution into the subterranean formation causes a reduction of the Sₒᵣ of the subterranean formation of at least 1% to 20% more than a reduction resulting from a conventional water flooding treatment.
Clause 9. The method of any one of clauses 1-8, wherein injection of the treatment solution into the subterranean formation causes a reduction of the Sₒᵣ) of at least 5% to 15% more than a reduction resulting from a conventional water flooding treatment.
Clause 10. The method of any one of clauses 1-9, wherein the treatment solution comprises a catalyst able to catalyze the dissociation of the at least one water soluble CO₂-generating compound.
Clause 11. The method of clause 10, wherein the catalyst is at least one of vanadium pentoxide and a carbon nanotube-silica nanohybrid nanoparticle.
Clause 12. The method of any one of clauses 1-11, wherein the treatment solution is introduced into the subterranean formation in the absence of a surfactant or chelating agent.
Clause 13. The method of any one of clauses 1-12, wherein oil recovery is enhanced by an amount at least 5% greater than oil recovery obtained by conventional water flooding.
Clause 14. The method of any one of clauses 1-13, wherein oil recovery is enhanced by an amount in a range of 1% to 35% greater than oil recovery obtained by conventional water flooding.
Clause 15. The method of any one of clauses 1-14, wherein oil recovery is enhanced by an amount in a range of 5% to 25% greater than oil recovery obtained by conventional water flooding.
Clause 16. The method of any one of clauses 1-15, wherein the reservoir of the subterranean formation is an unconventional reservoir.
Clause 17. A method for enhancing recovery from a subterranean formation, comprising: injecting a treatment solution containing at least one water soluble CO₂-generating compound into a subterranean formation containing oil and/or natural gas, wherein the at least one water soluble CO₂-generating compound dissociates to form CO₂, thereby enhancing recovery of at least one of oil and natural gas recovery therefrom, wherein the treatment solution is used to treat the subterranean formation in the absence of a surfactant or chelating agent.
Clause 18. The method of clause 17, wherein the at least one water soluble CO₂-generating compound is selected from the group consisting of ammonium carbamate and urea.
Clause 19. The method of either of clauses 17 or 18, wherein the treatment solution comprises a catalyst able to catalyze the dissociation of the at least one water soluble CO₂-generating compound.
Clause 20. The method of any one of clauses 17-19, wherein the catalyst is at least one of vanadium pentoxide and carbon nanotube-silica nanohybrid nanoparticle.
Clause 21. The method of any one of clauses 17-20, wherein the concentration of the at least one water soluble CO₂-generating compound in the treatment solution is in a range of about 1% to about 15%.
Clause 22. The method of any one of clauses 17-21, wherein the concentration of the at least one water soluble CO₂-generating compound in the treatment solution is in a range of about 2% to about 10%.
Clause 23. The method of any one of clauses 17-22, wherein the concentration of the at least one water soluble CO₂-generating compound in the treatment solution is in a range of 5% to 8%.
Clause 24. The method of any one of clauses 17-23, wherein injection of the treatment solution into the subterranean formation causes at least one of oil phase swelling, reduction of oil viscosity, and reduction of oil-water interfacial tension in the subterranean formation.
Clause 25. The method of any one of clauses 17-24, wherein injection of the treatment solution into the subterranean formation causes a reduction of the residual oil saturation (Sₒᵣ) of the subterranean formation of at least 1% more than a reduction resulting from a conventional water flooding treatment.
Clause 26. The method of any one of clauses 17-25, wherein injection of the treatment solution into the subterranean formation causes a reduction of the Sₒᵣ of the subterranean formation of at least 1% to 20% more than a reduction resulting from a conventional water flooding treatment.
Clause 27. The method of any one of clauses 17-26, wherein injection of the treatment solution into the subterranean formation causes a reduction of the Sₒᵣ) of at least 5% to 15% more than a reduction resulting from a conventional water flooding treatment.
Clause 28. The method of any one of clauses 17-27, wherein oil recovery is enhanced by an amount at least 5% greater than oil recovery obtained by conventional water flooding.
Clause 29. The method of any one of clauses 17-28, wherein oil recovery is enhanced by an amount in a range of 1% to 35% greater than oil recovery obtained by conventional water flooding.
Clause 30. The method of any one of clauses 17-29, wherein oil recovery is enhanced by an amount in a range of 5% to 25% greater than oil recovery obtained by conventional water flooding.
Clause 31. The method of any one of clauses 17-30, wherein the reservoir of the subterranean formation is an unconventional reservoir.

While the present disclosure has been described herein in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure as defined herein. Thus the examples described above, which include particular embodiments, will serve to illustrate the practice of the inventive concepts of the present disclosure, it being understood that the particulars shown are by way of example and for purposes of illustrative discussion of particular embodiments only and are presented in the cause of providing what is believed to be the most useful and readily understood description of procedures as well as of the principles and conceptual aspects of the present disclosure. Changes may be made in the formulation of the various compositions described herein, the methods described herein or in the steps or the sequence of steps of the methods described herein without departing from the spirit and scope of the present disclosure. Further, while various embodiments of the present disclosure have been described in claims herein below, it is not intended that the present disclosure be limited to these particular claims.

What is claimed is:

1. A method for enhancing recovery from a subterranean formation, comprising:
injecting a treatment solution containing at least one water soluble CO₂-generating compound into a subterranean formation containing oil and/or natural gas, wherein the at least one water soluble CO₂-generating compound dissociates to form CO₂, thereby enhancing recovery of at least one of oil and natural gas recovery therefrom.

2. The method of claim 1, wherein the at least one water soluble CO₂-generating compound is selected from the group consisting of ammonium carbamate and urea.

3. The method of claim 1, wherein the concentration of the at least one water soluble CO₂-generating compound in the treatment solution is in a range of about 1% to about 15%.

4. The method of claim 1, wherein the concentration of the at least one water soluble CO₂-generating compound in the treatment solution is in a range of about 2% to about 10%.

5. The method of claim 1, wherein the concentration of the at least one water soluble CO₂-generating compound in the treatment solution is in a range of 5% to 8%.

6. The method of claim 1, wherein injection of the treatment solution into the subterranean formation causes at least one of oil phase swelling, reduction of oil viscosity, and reduction of oil-water interfacial tension in the subterranean formation.

7. The method of claim 1, wherein injection of the treatment solution into the subterranean formation causes a reduction of the residual oil saturation (Sₒᵣ) of the subterranean formation of at least 1% more than a reduction resulting from a conventional water flooding treatment.

8. The method of claim 1, wherein injection of the treatment solution into the subterranean formation causes a reduction of the Sₒᵣ of the subterranean formation of at least 1% to 20% more than a reduction resulting from a conventional water flooding treatment.

9. The method of claim 1, wherein injection of the treatment solution into the subterranean formation causes a reduction of the Sₒᵣ) of at least 5% to 15% more than a reduction resulting from a conventional water flooding treatment.

10. The method of claim 1, wherein the treatment solution comprises a catalyst able to catalyze the dissociation of the at least one water soluble CO₂-generating compound.

11. The method of claim 10, wherein the catalyst is at least one of vanadium pentoxide and a carbon nanotube-silica nanohybrid nanoparticle.

12. The method of claim 1, wherein the treatment solution is introduced into the subterranean formation in the absence of a surfactant or chelating agent.

13. The method of claim 1, wherein oil recovery is enhanced by an amount at least 5% greater than oil recovery obtained by conventional water flooding.

14. The method of claim 1, wherein oil recovery is enhanced by an amount in a range of 1% to 35% greater than oil recovery obtained by conventional water flooding.

15. The method of claim 1, wherein oil recovery is enhanced by an amount in a range of 5% to 25% greater than oil recovery obtained by conventional water flooding.

16. The method of claim 1, wherein the reservoir of the subterranean formation is an unconventional reservoir.

17. A method for enhancing recovery from a subterranean formation, comprising:
injecting a treatment solution containing at least one water soluble CO₂-generating compound into a subterranean formation containing oil and/or natural gas, wherein the at least one water soluble CO₂-generating compound dissociates to form CO₂, thereby enhancing recovery of at least one of oil and natural gas recovery therefrom, wherein the treatment solution is used to treat the subterranean formation in the absence of a surfactant or chelating agent.

18. The method of claim 17, wherein the at least one water soluble CO₂-generating compound is selected from the group consisting of ammonium carbamate and urea.

19. The method of claim 17, wherein the treatment solution comprises a catalyst able to catalyze the dissociation of the at least one water soluble CO₂-generating compound.

20. The method of claim 19, wherein the catalyst is at least one of vanadium pentoxide and carbon nanotube-silica nanohybrid nanoparticle.
